(19) United States
(12) Patent Application Publication
(10) Pub. No.: US 2007/0294737 A1
(43) Pub. Date: Dec. 20, 2007

(54) Internet Protocol Television (IPTV) stream management within a home viewing network

(75) Inventors: Greg Edwards, Austin, TX (US); Marc Sullivan, Austin, TX (US)

Correspondence Address: SCHWEGMAN, LUNDBERG & WOESSNER, P.A., P.O. BOX 2938, MINNEAPOLIS, MN, 55402, US

(73) Assignee: SBC Knowledge Ventures, L.P.

(21) Appl. No.: 11/454,314

(22) Filed: Jun. 16, 2006

(51) Int. Cl. H04N 7/173

(52) U.S. Cl. 725/112; 725/113; 725/97

(57) ABSTRACT

Techniques for Internet Protocol Television (IPTV) stream management within a home viewing network are provided. A plurality of IPTV streams are presented on viewing devices within the home viewing network. Descriptive information is presented with each of the presentations. The descriptive information includes at least a status for each of the IPTV streams and a location for each of the IPTV streams within the home viewing network. Moreover, the presentation permits selectable actions to be taken with respect to any of the IPTV streams within the home viewing network.

### FIELD

This application relates to Internet Protocol Television (IPTV) stream management, and more specifically to techniques for IPTV stream management within a home viewing network.

### BACKGROUND

Internet Protocol Television (IPTV) has provided a mechanism for which television transmissions can be received over the Internet and delivered to viewers within their homes. This Internet home television delivery presents a variety of beneficial features previously not available, such as providing multiple simultaneous television feeds within the home network and providing convenient software programming options using convention software programming associated with the Internet and conventional user computing devices.

Yet, the programming options are largely still in the control of conventional technical programmers and defined and controlled by them based on what they believe viewers want and need. That is, control of the programming is not afforded to the viewers based on their own individual needs or desires. Furthermore, even if control were afforded to the viewers the viewers often lack the requisite informational awareness about each of the IPTV streams within their networks to make cogent control changes that they may desire.

Thus, techniques for more efficiently managing IPTV streams are desirable, which provide more control and awareness to the viewers within the home networks that have IPTV stream capabilities.

### BRIEF DESCRIPTION OF DRAWINGS

The present disclosure is illustrated by way of example and not limitation in the figures of the accompanying drawings, in which like references indicate similar elements and in which:

FIG. 1 is a diagram of a method for managing Internet Protocol Television (IPTV) streams within a home network, according to an example embodiment of the disclosure.

FIG. 2 is a diagram of another method for managing IPTV streams within a home network, according to an example embodiment of the disclosure.

FIG. 3 is a diagram of still another method for managing IPTV streams within a home network, according to an example embodiment of the disclosure.

FIG. 4 is diagram of a home-based IPTV stream management system, according to an example embodiment of the disclosure.

FIGS. 5A-5C are example screen interfaces associated with any one of the methodologies discussed herein, according to an example embodiment of the disclosure.

FIG. 6 is a diagram of an example network architecture for devices, machines, services, systems, and instructions to interact and perform any one or more of the methodologies discussed herein, according to an example embodiment of the disclosure.

FIG. 7 is a diagram of an example machine architecture within which a set of instructions for causing the machine to perform any one or more of the methodologies discussed herein may be executed, according to an example embodiment of the disclosure.

### DETAILED DESCRIPTION

In the following description, for purposes of explanation, numerous specific details are set forth in order to provide a thorough understanding of an embodiment of the present disclosure. It will be evident, however, to one skilled in the art that the present disclosure may be practiced without these specific details.

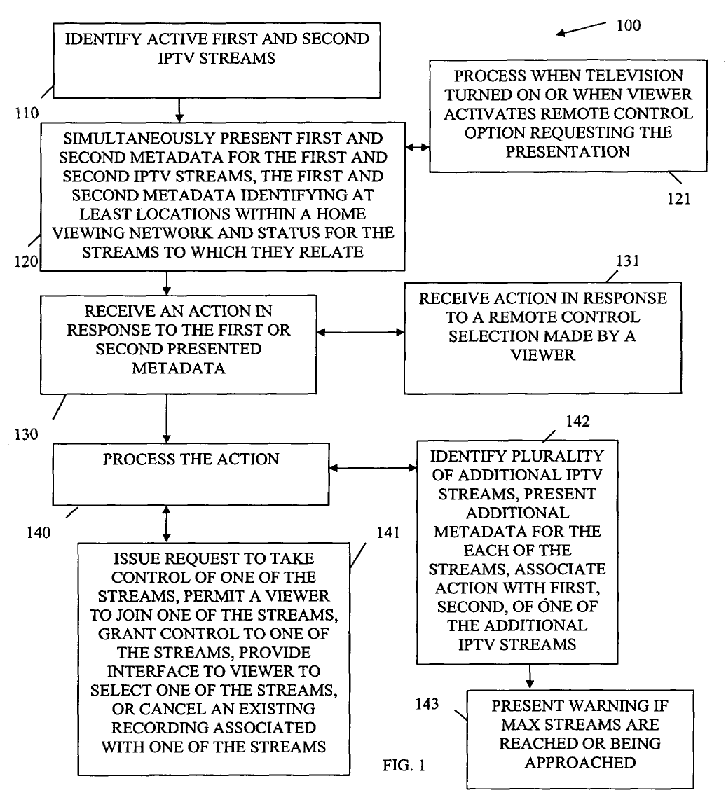

FIG. 1 is a diagram of a method 100 for managing Internet Protocol Television (IPTV) streams within a home network, according to an example embodiment of the disclosure. The method 100 (herein after referred to as “server-based IPTV management service”) is implemented in a machine-accessible medium and is operational over a network. The network may be wired, wireless, or a combination of wired and wireless.

The server-based IPTV management service operates within a home viewing network. A home viewing network is a network that has an IPTV server, one or more remote devices, perhaps one or more Set-Top Boxes (STB's), and one or more viewing devices. The IPTV server receives and broadcasts, within the home network, IPTV streams associated with television broadcasts, pay-per view broadcasts, Internet video broadcasts, and the like. The maximum number of available IPTV streams is bounded by the IPTV server capabilities or the maximum bandwidth capabilities of the home viewing network. The minimum number of IPTV streams available within the home viewing network is at least two.

The components of the home viewing network may be arranged in any desired fashion. The IPTV server interfaces with an IPTV provider over the Internet. The network may be wired, wireless, or a combination of wired and wireless. It is also noted that although the term “home” is used in connection with the phrase “home viewing network” that the network is not limited to a residential home or dwelling. That is, any local area network within a defined area viewing area accessible to a single account with an IPTV provider may be viewed as a home viewing network.

A viewing device is a television or a monitor that permits video or television broadcasts to be viewed thereon. Each remote viewing device interfaces with the IPTV server over the network. In some cases, a STB (Digital Versatile Recorder (DVR), etc.) may be viewed as a remote viewing device, if that STB includes the processing instructions associated with directly interfacing with the IPTV server of the home viewing network. Moreover, each remote viewing device directly interfaces with a viewing device that is capable of presenting the IPTV streams of the home viewing network. Also, in some cases where the remote viewing device is not a STB, a remote viewing device may be directly interfaced with that STB.

According to an embodiment, at least one STB within the home viewing network is capable of receiving each IPTV stream available within the home viewing network. This arrangement permits the STB to record any desired IPTV stream on request or demand.

With this context, the server-based IPTV management service and its associated processing capabilities will now be discussed with reference to FIG. 1. Further, as noted above the server-based IPTV management service may be implemented within an IPTV server.

At 110, the server-based IPTV management service identifies a first active IPTV stream available within the home viewing network and a second active IPTV stream. A variety of additional IPTV streams may be capable within the network, but for purposes of illustration and comprehension the processing of the server-based IPTV management service is discussed, at least initially, within the context of a minimum of two IPTV streams (first IPTV stream and second IPTV stream). The streams are active in the sense that at least two remote viewing devices are consuming or using the first and second IPTV streams.

At 120, the server-based IPTV management service simultaneously presents first metadata associated with the first IPTV stream and second metadata associated with the second IPTV stream. Metadata is descriptive information about a particular IPTV stream to which it relates. The descriptive information at least includes a status associated with an IPTV stream and a location.

The status may include a variety of configurable information, such as descriptive text indicating that a particular stream is not in use within the home viewing network, is actively being watched or consumed somewhere within the home viewing network, is actively being recorded within the home viewing network, a type description for an IPTV stream within the home viewing network (e.g., live television, pay-per-view, Internet feed, Video, Digital Versatile Disk playing on a DVD player or STB, etc.), and the like.

The location identifies where within the home viewing network that an IPTV stream is being consumed or used. In other words, the location may identify the name of a viewing device, a name of remote viewing device, a name of a STB, a user or viewer-defined name that indicates location of an IPTV stream within the home viewing network (e.g., family room, master bedroom, den, basement, kitchen, garage, etc.), and the like.

The metadata may also include other information. For example, it may include a channel number, a network name, a descriptive title associated with a particular IPTV stream, and the like. Still further, the metadata may include a descriptive summary of the programming for any given IPTV stream.

The metadata provides informational awareness of an IPTV stream to a viewer via a viewing device within the home viewing network. This empowers the viewer with information about a particular available IPTV stream. By combining at least the first and second metadata and presenting them together, a viewer can quickly become aware of multiple IPTV streams from any viewing device within the home viewing network on demand or by default when a viewing device is started up or turned on from an initial off position by a viewer. This empowers the viewer with a full awareness of the IPTV streams within the home viewing network and, as will be discussed in greater detail below, allows the viewer to take control and actions to change or alter selective and desired IPTV streams.

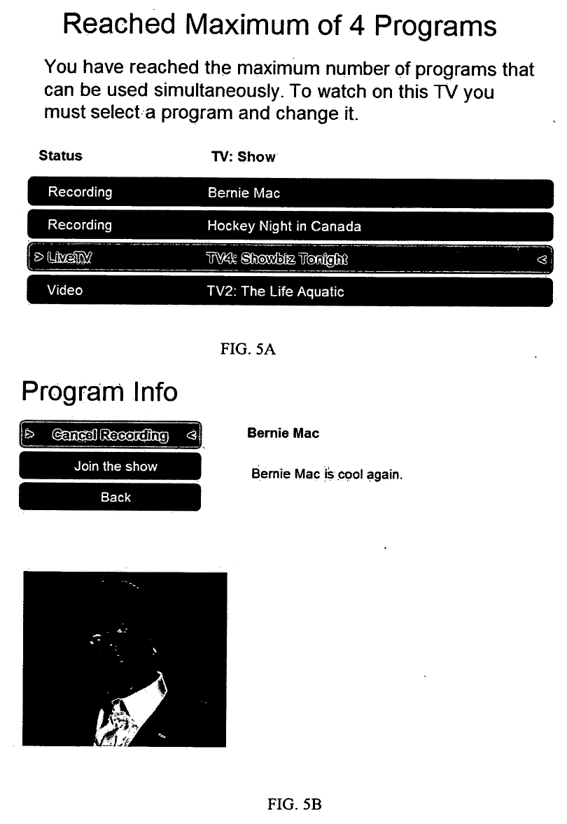

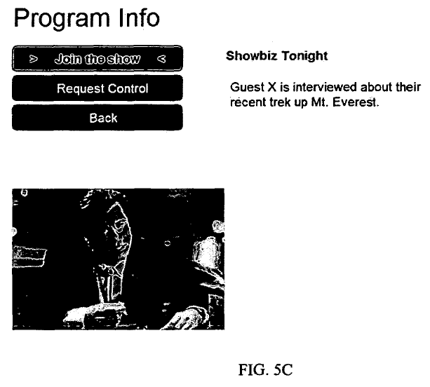

Example metadata and the presentation associated therewith are described below with respect to FIGS. 5A-5C.

According to an embodiment, at 121, the server-based IPTV management service may process the presentation of the first and second metadata when a television or viewing device is turned on or when a viewer activates a remote control option requesting the presentation. To achieve this, the server-based IPTV management service interacts with a remote viewing device associated with the viewing device to which the viewer turned on or used a remote control command or action to request the presentation.

At 130, the server-based IPTV management service receives an action in response to the first or second presented metadata. So, options or actions are available to a viewer within the presentation for affecting some change with respect to the first and/or second IPTV streams. In an embodiment, at 131, the viewer uses a remote control device interfaced to a remote viewing device of the viewer when the presentation with actions are presented on the viewing device and where that presentation is presented to the viewer. The remote viewing device then communicates that action to the server-based IPTV management service over the home viewing network.

At 140, the server-based IPTV management service processes the action in response to its receipt. The processing may achieve a variety of changes or modifications to the IPTV streams within the home viewing network. For example, at 141, the action may be processed to issue a request from a viewer to take control of one of the IPTV streams not currently associated with that viewer's viewing device, to permit the viewer to join one of the IPTV streams not currently associated with the IPTV stream that the viewer is actively consuming, to provide an interface to the viewer for purposes of selecting one of the IPTV streams, to cancel an existing recording associated with one of the IPTV streams, and to do other desired or configured actions.

According to an embodiment, at 142, the server-based IPTV management service may identify a variety of additional IPTV streams. These may also have their own independent metadata that is presented to a viewer, and the actions processed, at 140, may be related to one of these additional IPTV streams or the first or second IPTV streams in response to that additional metadata that is presented to the viewer. In some cases, at 143, the server-based IPTV management service may also present a warning if a maximum number of IPTV streams have been reached within the home viewing network or if that maximum number of IPTV streams is being approached within some predefined threshold. So, as an example, if the home viewing network has a maximum of 10 IPTV streams, and the network is actively consuming 9, then a threshold of 1 may indicate that when 9 is reached (max (10)−consumed (9)=threshold (1)) the server-based IPTV management service should issue a warning to the viewers of the home viewing network.

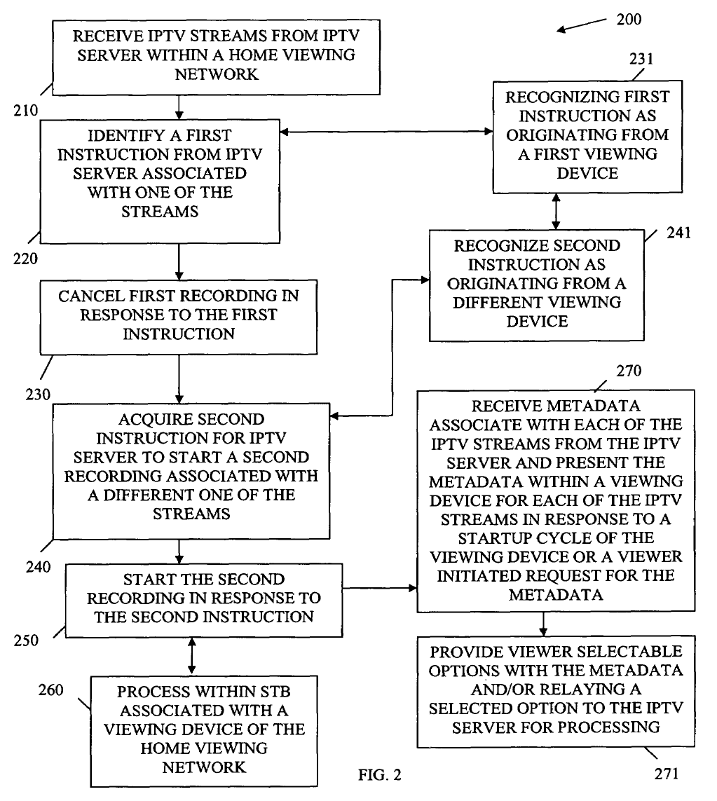

FIG. 2 is a diagram of another method 200 for managing IPTV streams within a home network, according to an example embodiment of the disclosure. The method 200 (hereinafter referred to as “client-based IPTV management service”) is implemented in a machine-accessible and readable medium and is operational over a network. The network may be wired, wireless, or a combination of wired and wireless.

In an embodiment, the client-based IPTV management service interacts with the server-based IPTV management service represented by the method 100 of the FIG. 1. The client-based IPTV management service operates as a plurality of duplicate independent services within a home viewing network, where each instance of the service is associated with a particular viewing device or Set-Top Box (STB) within the home viewing network. So, the client-based IPTV management service is implemented within each remote viewing device within the home viewing network.

At 210, the client-based IPTV management service receives IPTV streams from an IPTV server within a home viewing network. If the IPTV server implements the server-based IPTV management service represented by the method 100 of the FIG. 1, then the client-based IPTV management service interfaces with that server-based IPTV management service to receive the IPTV streams and to perform a variety of other actions described in greater detail below.

At 220, the client-based IPTV management service identifies a first instruction from the IPTV server; the first instruction associated with one of the IPTV streams within the home viewing network. According to an embodiment, the client-based IPTV management service may recognize the first instruction as originating from a first viewing device. So, as an example, the client-based IPTV management service may detect that the first instruction is associated with viewing device directly interfaced to the client-based IPTV management service.

At 230, the first instruction is recognized as a cancellation of a first recording associated with the one of the IPTV streams. That is, a particular IPTV stream is being actively recorded and the first instruction is processed by the client-based IPTV management service to cancel that first recording.

At 240, the client-based IPTV management service acquires a second instruction from the IPTV server associated with starting a second recording associated with a different one of the IPTV streams. In some cases, at 241, the client-based IPTV management service may recognize that the second instruction originated from a different viewing device from which the first instruction originated. So, the IPTV server may include information in the instructions that permits the client-based IPTV management service to identify viewing devices from which the instructions are emanating or originating.

At 250, the client-based IPTV management service starts the second recording in response to receipt of the second recording. Essentially, any two viewers within the home viewing network are able to use their viewing devices to access remote viewing devices having instructions representing instances of the client-based IPTV management service and may cancel a first recording associated with a first IPTV stream and start a second recording associated with a second IPTV stream.

According to an embodiment, at 260, the processing associated with the client-based IPTV management service is processed within a STB associated with a particular viewing device within the home viewing network. So, recordings of IPTV streams can be started and stopped on demand from any other viewing device within the home viewing network via communications between the IPTV server and processing instances of the client-based IPTV management service and one particular instance may be implemented within a STB of the home viewing network.

In still another embodiment, at 270, the client-based IPTV management service may receive metadata associated with each IPTV stream available over the home viewing network from the IPTV server. Examples of metadata were presented above with respect to the server-based IPTV management service represented by the method 100 of the FIG. 1. The client-based IPTV management service may then assist the IPTV server in presenting the metadata associated with each IPTV stream within a viewing device to which the client-based IPTV management service is interfaced. The presentation may be in response to a detected startup cycle of the viewing device or in response to viewer-initiated request for the metadata.

At 271, the client-based IPTV management service may also provide viewer selectable options with the metadata and may then also relay any selected options activated from a viewer to the IPTV server. This processing was also described from the perspective of the IPTV server with the server-based IPTV management service represented by the method 100 of FIG. 1.

Essentially, the client-based IPTV management service acts as an intermediary between the IPTV server and a viewer that is viewing a particular IPTV stream on that viewer's viewing device. The client-based IPTV management service also stops and starts recordings. The instructions may be received from any viewer within the home viewing network and communicated through the IPTV server to the client-based IPTV management service for processing.

Again, the client-based IPTV management service is presented from the perspective of a remote viewing device within the home viewing network. In some cases, that remote viewing device may be a STB, such as a DVR. Additionally, the client-based IPTV management service stays in synch and is capable of receiving instructions from any viewer within the network via the IPTV server that directly interfaces with each remote viewing device of the home viewing network and each remote viewing device is capable of having an active viewer interfacing with it.

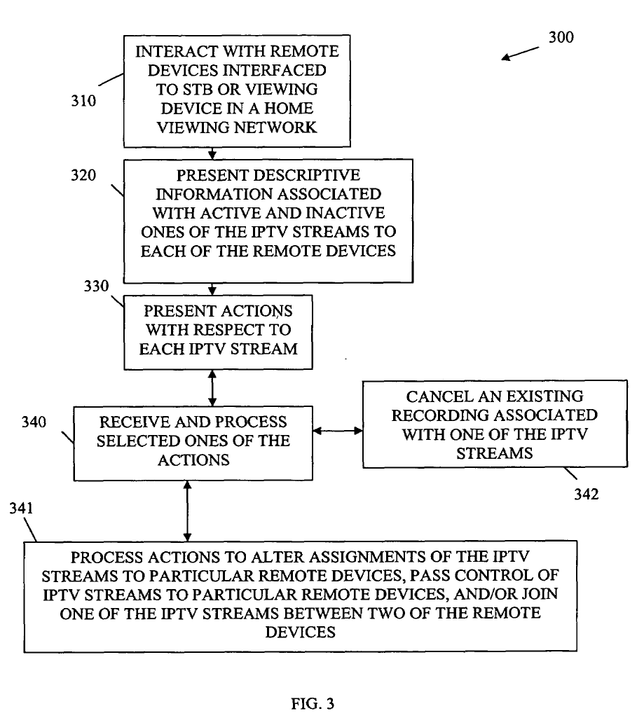

FIG. 3 is a diagram of still another method 300 for managing IPTV streams within a home network, according to an example embodiment of the disclosure. The method 300 is implemented as instructions within a machine-accessible and readable medium and is operational over a network. The network may be wired, wireless, or a combination of wired and wireless. The instructions when executed by a machine within the home viewing network represent an alternative processing perspective to the server-based IPTV management service represented by the method 100 of the FIG. 1 and interact with instances of the client-based IPTV management service represented by the method 200 of the FIG. 2.

The instructions may be implemented on a removable medium and subsequently interfaced to a machine where the instructions are uploaded within the machine and processed. Alternatively, the instructions may be prefabricated within memory or storage of the machine and loaded for execution when the machine is initiated or booted. In still another arrangement, the instructions may be downloaded from a network storage location or other network machine to a target machine on the network and processed. In yet another situation, the instructions may be remotely processed over a network on one machine at the instruction and on behalf of another different network machine.

At 310, the instructions interact with remote devices (remote viewing devices) that are interfaced to a viewing device and/or may a STB, such as a DVR, etc. The communication between the instructions and the remote devices occur over a home viewing network.

At 320, the instructions present descriptive information (e.g., metadata) that is associated with active and inactive ones of IPTV streams available over the home viewing network for consumption by the viewing devices or STB's interfaced to the remote devices that interaction with the instructions.

The presented descriptive information is pushed to the remote devices upon the detection of an event. That event may be detection of a situation where a viewing device associated with a particular remote device has started up. The event may also be a viewer initiated instruction from a viewing device of a particular remote device.

The descriptive information includes at least a status indication for each of the active and inactive IPTV streams available within the home viewing network and an identifier for active ones of the IPTV streams, which indicates or identifies a particular viewing device currently using or consuming a particular one of the active IPTV streams. Examples of the status and the identifier were provided above with the server-based IPTV management service represented by the method 100 of the FIG. 1. So, the descriptive information that the instructions push to remote devices upon detection of an event will identify for viewers via their viewing devices each IPTV stream within the home viewing network and, minimally, a status for each IPTV stream and an effective location for each IPTV stream.

According to an embodiment, at 330, the instructions may also present actions that may be taken by a viewer with respect to each of the IPTV streams. The actions are presented with the descriptive information. In response to this, at 340, the instructions may receive selected ones of the actions from the remote devices as initiated by the viewers associated with those viewing devices. Those actions may then be processed, at 341. Some example processing may include, but is not limited to, altering assignments of the IPTV streams between remote devices and their corresponding viewing devices, passing control of IPTV streams to particular remote devices and remove control from other remote devices, joining one of the IPTV streams between at least two or more of the remote devices, and the like.

In some cases, 342, an action may result in the cancellation of an existing recording in progress on a STB within the home viewing network with respect to one of the IPTV streams.

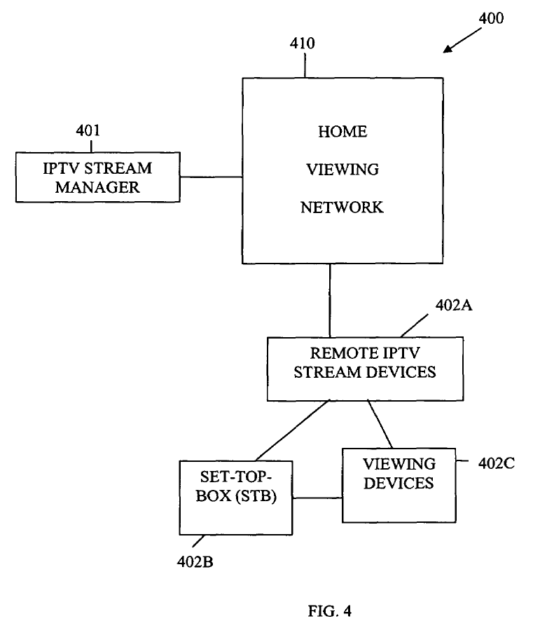

FIG. 4 is a diagram of a home-based IPTV stream management system 400, according to an example embodiment of the disclosure. The home-based IPTV stream management system 400 is implemented within a machine readable medium and on a plurality of machines within a home viewing network. The home-based IPTV stream management system 400 implements, among other things, the processing associated with the methods 100, 200, and 300 of the FIGS. 1-3, respectively.

The home-based IPTV stream management system 400 includes an IPTV stream manager 401 and a plurality of remote IPTV stream devices 402A. Each remote IPTV stream device 402A is interfaced directly to a STB 402B and/or a viewing device 402C. The components of the home-based IPTV stream management system 400 interact within a home viewing network 410. Each of these components will now be discussed in turn.

The IPTV stream manager 401 is the controller of the IPTV stream distributions throughout the home viewing network 410 and effectuates changes in assignment or status of those IPTV streams. The IPTV stream manager 401 also provides descriptive information or metadata about each IPTV stream within the home viewing network 410 to each remote IPTV stream device 402A, such that viewers associated with the viewing devices 402C can make intelligent decisions about IPTV streams within the home viewing network 410 and acquire knowledge about the entire home viewing network 410 and the status and location of each IPTV stream within the home viewing network 410. Changes to the IPTV stream in terms of assignments, recordings, and the like are also effectuated through the IPTV stream manager 401 via actions received from the remote IPTV stream devices 402A; the IPTV stream devices 402A receive the actions from selections made by viewers interfaced to the viewing devices 402C and perhaps the STB's 402B.

In an embodiment, the IPTV stream manager 401 includes an interface that is presented to each of the remote IPTV stream devices 402A. The interface is used to present the descriptive information and the actions and is also used to receive selection of the actions from each of the remote IPTV stream devices 402A.

In one aspect of the IPTV stream manager 401, the IPTV stream manager 401 issues a warning to each of the remote IPTV stream devices 402A when a maximum number of the available IPTV streams within the home viewing network 410 is reached or is being approached within a predefined threshold.

According to an embodiment, the IPTV stream manager 401 may implement the techniques and processing associated with the server-based IPTV management service represented by the method 100 of the FIG. 1 and/or the instructions represented by the method 300 of the FIG. 3.

The remote IPTV stream devices 402A act as receivers and transmitters of information between the IPTV stream manager 401 and the STB's 402B or viewing devices 402C. Each remote IPTV stream device 402A may implement the client-based IPTV management service represented by the method 200 of the FIG. 2.

The remote IPTV stream devices 402A present the descriptive information for available IPTV streams within the home viewing network 410 via instruction and data received from the IPTV stream manager 401. The remote IPTV stream devices 402A also present actions with the descriptive information and receive selections to the actions. The presentations occur on the viewing devices 402C that a viewer watches. The actions to take may be viewed as options presented with the descriptive information to the viewers.

The options may include such things as permitting one of the remote IPTV stream devices 402A (remote IPTV devices 402A) to join a particular one of the IPTV streams that is associated with another or different one of the remote IPTV devices 402A, taking or requesting control from one remote IPTV device 402A of a particular IPTV stream that is associated with another remote IPTV device 402A, cancelling a recording associated with one of the IPTV streams being recorded on one of the STB's 402B, and others.

In some embodiments, at least one STB 402B of the home viewing network 410 is directly interfaced to a viewing device 402C and to one of the remote IPTV devices 402A. In other cases, a STB 402B includes a remote IPTV device 402A embedded therein and is capable of directly interacting with the IPTV stream manager 401.

FIGS. 5A-5C are example screen interfaces associated with any one of the methodologies discussed herein, according to an example embodiment of the disclosure.

FIG. 5A illustrates example metadata or descriptive information that is presented on a viewing device within a home viewing network for each active and available IPTV stream within the home viewing network. In this example, there are 4 IPTV streams available within the example home viewing network. The metadata includes a status (e.g., “recording,” “Live TV,” and “Video”). The metadata may also include descriptive titles for each of the 4 IPTV streams (e.g., “Bernie Mac,” “Hockey Night in Canada’” “TV4: Showbiz Tonight,” and “TV2: The Life Aquatic”). The two labels “TV4” and “TV2” embedded within the descriptive title may also be viewed as location identifiers for the metadata, which identifies a location within the home network for a particular IPTV stream.

FIG. 5B shows another example of a presentation that includes actions that a viewer may take with respect to a particular IPTV stream being watched on a viewing device by that viewer. So, in the example the IPTV stream is the Bernie Mac Show, entitled “Bernie Mac is cool again.” The actions are listed as: “Cancel Recording,” “Join the Show,” and “Back.” The viewer may activate these actions and change status of the Bernie Mac IPTV stream or recording, as the case may be.

FIG. 5C shows still another example of a presentation that includes actions that a viewer may take with respect to a particular IPTV stream being watched on a viewing device by that viewer. Here, Showbiz Tonight is being watched and the actions selectable by the viewer include: “Join the show,” “Request Control,” and “Back.” Again, the viewer may activate these actions and change the status of the Showbiz Tonight IPTV stream; however, the “Request Control” action may not immediately change the status, rather, this may ask another viewer if control can be permissible passed to another viewer that is requesting the control.

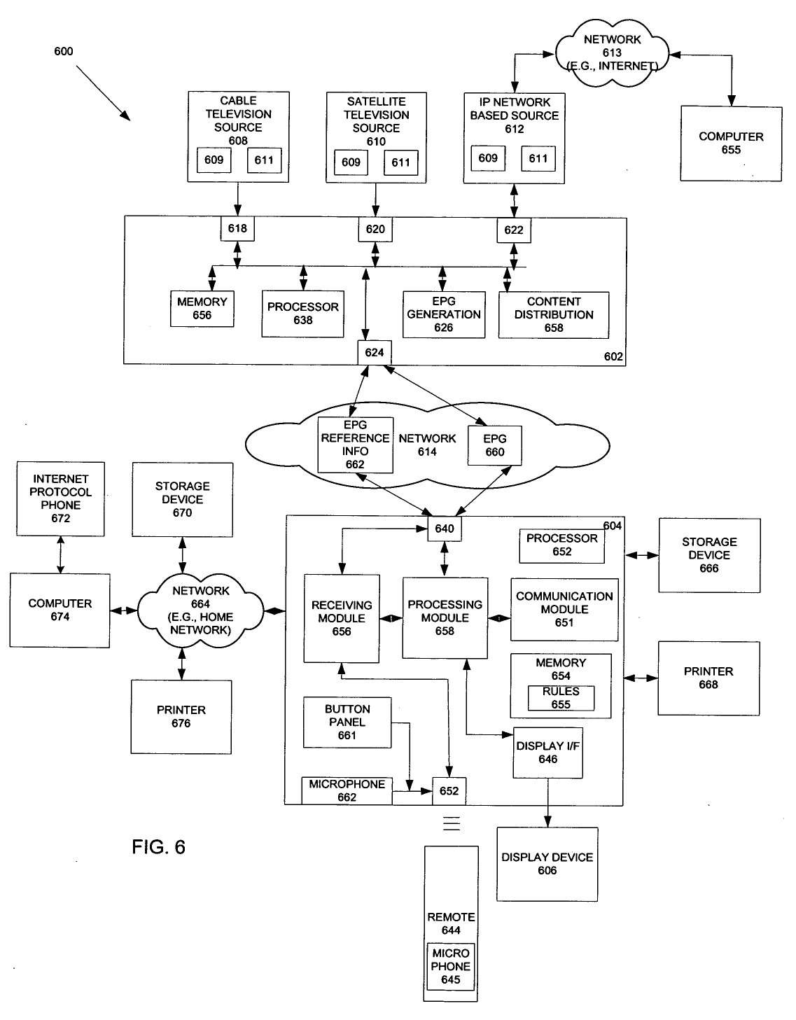

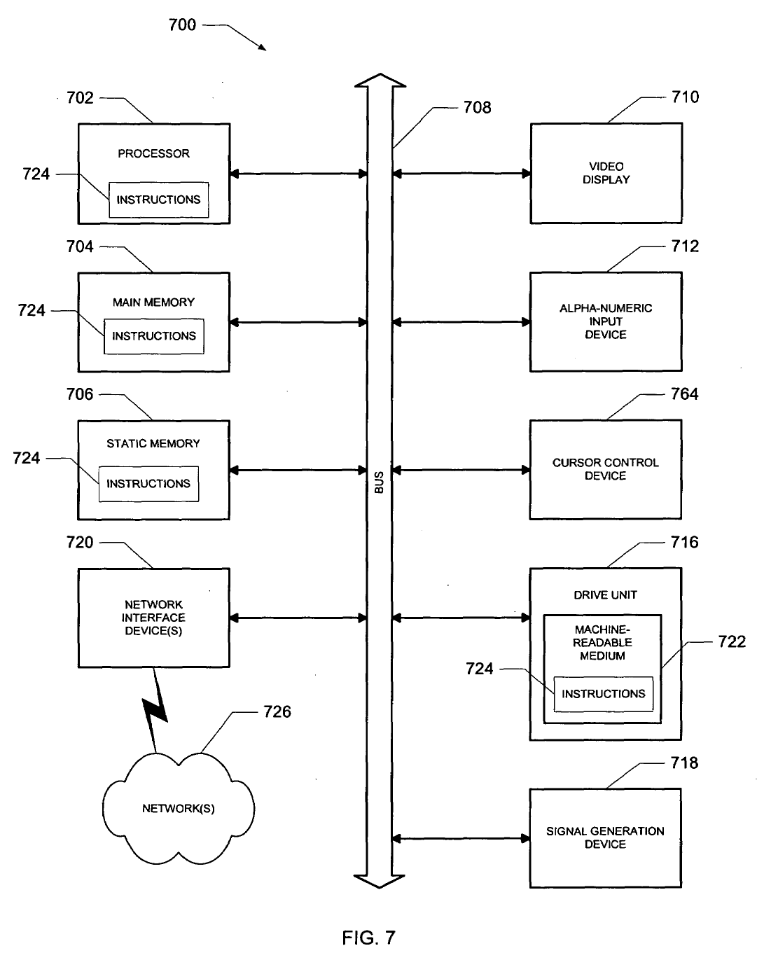

FIGS. 6-7 are now presented for purposes of providing an example network architecture and machine architecture for which devices can interact to achieve the teachings and techniques presented herein. This layout and configuration is presented for purposes of illustration only and is not intended to limit the embodiments presented herein.

FIG. 6 is a diagram of an example network architecture 600 for devices, machines, services, systems, and instructions to interact and perform any one or more of the methodologies discussed herein, according to an example embodiment of the disclosure.

FIG. 6 may also be viewed as an example multimedia distribution system 600 that is implemented in accordance with at least one embodiment of the present disclosure. As shown, the system 600 includes a multimedia content provider 602, a set-top box 604, a display device 606, a plurality of multimedia content sources, such as cable television source 608, satellite television source 610, and IP network-based source 612.

In the illustrated embodiment, the content provider 602 and the set-top box 604 are connected via a network 614, where the network 614 can include a cable television distribution network, a satellite distribution network, a broadcast television distribution network, a data packet-based computer network (e.g., an Ethernet network), and the like. Likewise, the content sources 608, 610, and 612 may be connected via one or more networks to the content provider 602.

As shown, the content provider 602 can include one or more interfaces 618, 620, and 622 to interface with the content sources 608, 610, and 612, respectively, and an interface 624 to interface with the set-top box 604 via the network 614. The interfaces 618, 620, 622, and 624 may include any of a variety of interfaces, such as a coaxial cable interface, a wireless interface for receiving satellite or broadcast transmissions, or a data packet network interface, such as an Ethernet interface or a router. The IP Network based source 612 is shown to be connected to a computer 615 over a network 613 (e.g., Internet) thereby providing a communication path between a user operating the set-top box 604 and a user operating the computer 615. The content provider 602 further may include an EPG generation module 626 and a multimedia content distribution module 628. The modules 626 and 628 may be implemented as software, hardware, firmware, or combinations thereof. To illustrate, the content provider 602 may include a memory 636 (e.g., static random access memory (SRAM)) and one or more processors 638, where the modules 626 and 628 may be implemented in part or in whole as executable instructions stored in the memory 636 and executed by the processor 638 to perform the techniques described herein.

As also shown, the set-top box 604 may include an interface 640 for interfacing with the content provider 602 via the network 614, a control interface 642 to receive user input and commands, (e.g., via a remote control 644, a button panel 661, a microphone 662) and a display interface 646 to interface with the display device 606. The interface 640 may include any of a variety of appropriate interfaces, such as a coaxial cable interface, a wireless interface to send and receive wireless transmissions, or a data packet-based network interface, such as an Ethernet interface. The control interface 642 may include any of a variety of interfaces, such as an infrared interface, a wireless interface, or the button panel 661. The remote control 644 is shown to include a microphone 645 for receiving voice commands and the set-top box 604 is also shown to include a microphone 662 for receiving voice commands.

The set-top box 604 is further shown to be connected to a storage device 666 (e.g., hard disk, compact disk, floppy, universal serial bus key, etc.) for storing files, a printer 668 for printing files, and a network 664 (e.g., home network). The network 664, in one embodiment, may connect the set-top box 604 to a computer 674 that is connected to an internet protocol phone 672, a storage device 670 for storing electronic files, and a printer 676. The set-top box 604 further may include a processing module 658, a receiving module 656, and a communication module 651. The processing module 658, receiving module 656, and communication module 651 may be implemented as hardware, software, firmware, or combinations thereof. To illustrate, the set-top box 604 may include a memory 654 and one or more processors 652, where one or both of modules 648 and 650 are implemented as executable instructions stored in memory 654 and executed by the processor 652 to implement techniques described herein. The memory is further shown to include rules 655 that may be utilized to control the use of images that may be captured from content that is displayed on the display device 606. For example the rules 655 may embodied as a digital rights management license that may be distributed with content from the content source 608, 610, and 612. As is well known in the art, the license may include rules 655 that may restrict the use of the associated content.

In a particular embodiment, the content provider 602 receives data representative of multimedia channels from each of the different content sources 608, 610, and 612, and provides data representative of at least a subset of the multimedia channels to the set-top box 604 for processing and display at the display device 606 and/or output via an audio device (not shown). In one embodiment, the content provider may include a content module 609 that communicates data that includes content and a control module 611 that may communicate data that includes control information (e.g., digital license) that may include a rule that restricts the use of associated content. Moreover, in a particular embodiment, the content provider 602 may provide data representative of an electronic programming guide (EPG) 660 to the set-top box 604 for processing by the processing module 658 and for navigation by a user via the control interface 642 and the processing module 658. As described herein, the EPG 660, in one embodiment, represents a unified EPG including listings for the multimedia channels provided by two or more content sources that provide multimedia channels to the content provider 602. To illustrate, in a particular embodiment, the EPG 660 represents a navigable program guide or user interface whereby a user, via the remote control 644 or other input device, can direct the processing module 650 to navigate between multimedia channels by selecting an icon or other graphical representation of the desired channel as represented by a graphical display of the EPG 660. The EPG 660 may combine representations of all of the multimedia channels from different content sources in a single list or different lists for different content sources may be displayed concurrently by the EPG 660. Moreover, multimedia channels may be organized within the EPG 660 based on any of a variety of characteristics, such as by the program content of the multimedia channels, where the program content describes the genre or categorization of the video/audio program represented by the multimedia channel. Examples of various genres or categories include a “comedy” genre, an “action” genre, a “family” genre or “children” genre, a “romance” genre, a “science-fiction” genre, and the like.

FIG. 7 is a diagram of an example machine architecture within which a set of instructions for causing the machine to perform any one or more of the methodologies discussed herein may be executed, according to an example embodiment of the disclosure.

Accordingly, FIG. 7 shows a diagrammatic representation of machine in the example form of a computer system 700 within which a set of instructions, for causing the machine to perform any one or more of the methodologies discussed herein, may be executed.

In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU) a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a cursor control device 714 (e.g., a mouse), a disk drive unit 716, a signal generation device 718 (e.g., a speaker) and a network interface device 720.

The disk drive unit 716 includes a machine-readable medium 722 on which is stored one or more sets of instructions (e.g., software 724) embodying any one or more of the methodologies or functions described herein. The software 724 may also reside, completely or at least partially, within the main memory 704 and/or within the processor 702 during execution thereof by the computer system 700, the main memory 704 and the processor 702 also constituting machine-readable media.

The software 724 may further be transmitted or received over a network 726 via the network interface device 720.

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure. The term “machine-readable medium” shall accordingly be taken to include, but not be limited to, solid-state memories, optical and magnetic media, and carrier wave signals.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. § 1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

What is claimed is:

1. A method including:
identifying active first and second Internet Protocol Television (IPTV) streams;
simultaneously presenting first metadata associated with the first IPTV stream and second metadata associated with the second IPTV stream, wherein the first and second metadata identify at least locations within a home viewing network for the each of the IPTV streams and status associated with each of the IPTV streams; and
receiving an action in response to the first metadata and the second metadata.

2. The method of claim 1 further including, processing the action.

3. The method of claim 2, wherein processing further includes at least one of:
issuing a request received from a first viewer to a second viewer, wherein the request is to take control of the second IPTV stream being watched by the second viewer;
permitting the first viewer associated with the first IPTV stream to join the second IPTV stream associated with the second viewer;
granting control of the second IPTV stream to the first viewer when the second IPTV stream is not actively being watched;
providing a selection interface to the first viewer to select between the first IPTV stream or the second IPTV stream to actively watch; and
canceling an existing recording associated with the first IPTV stream.

4. The method of claim 1 further including:
identifying a plurality of additional IPTV streams;
simultaneously presenting additional metadata associated with each of the additional IPTV streams;
associating the action with the first IPTV stream, the second IPTV stream, or one of the additional IPTV stream; and
processing the action.

5. The method of claim 4 further including, presenting a warning with the first, second, and additional metadata when a maximum number of IPTV streams is reached.

6. The method of claim 4 further including, presenting a warning with the first, second, and additional metadata when a maximum number of IPTV streams is approached within a given threshold.

7. The method of claim 1, wherein simultaneously presenting further includes detecting when a television associated with a viewer is turned on after having been turned off or when the viewer activates a remote control option associated with the television after the television is already on.

8. The method of claim 1, wherein receiving further includes receiving the action in response to a remote control selection made by a viewer of a television.

9. The method of claim 1 further including, representing the locations as at least one of a name associated with a viewing device for viewing one of the first or the second IPTV streams, a name associated with a remote device that supplies the first or the second IPTV streams to the viewing device, a name associated with a set-top-box, and a user-defined name associated with uniquely identifying the location of the first or the second IPTV streams.

10. The method of claim 1 further including, adding to the first or the second metadata as at least one of a channel number for presenting the first or the second IPTV streams, a network name associated with the first and the second IPTV streams, a descriptive title for the first or the second IPTV streams, and a descriptive summary associated with programming on the first or the second IPTV streams.

11. A method including:
receiving Internet Protocol Television (IPTV) streams from an IPTV server within a home viewing network;
identifying a first instruction from the IPTV server to cancel a first recording associated with one of the IPTV streams;
canceling the first recording in response to the first instruction;
acquiring a second instruction from the IPTV server to start a second recording associated with a different one of the IPTV streams; and
starting the second recording in response to the second instruction.

12. The method of claim 11, wherein identifying further includes recognizing the first instruction as originating from a remote viewing device within the home viewing network and in communication with the home viewing network.

13. The method of claim 11, wherein identifying and acquiring further include:
recognizing the first instruction as originating from a first viewing device within the home viewing network; and
recognizing the second instruction as originating from a second and different viewing device within the home network.

14. The method of claim 11 further including:
receiving metadata associated with each of the IPTV streams from the IPTV server; and
presenting the metadata within a viewing device for each of the IPTV streams in response to at least one of a startup cycle associated with the viewing device and a viewer initiated request for the metadata.

15. The method of claim 14 further including, providing one or more viewer selectable options with the metadata within the viewing device.

16. The method of claim 15 further including, relaying a selected one of the options to the IPTV server for processing in response to a viewer selection.

17. A machine accessible medium having instructions embedded thereon, the instructions when accessed by a machine perform the method of:
interacting with remote devices, wherein each remote device is interfaced to at least one of a Set-Top Box (STB) and a viewing device within a home viewing network; and
presenting descriptive information associated with active and inactive ones of Internet Protocol Television (IPTV) streams available within the home viewing network to each of the remote devices on request or when a particular viewing device starts up, wherein the descriptive information includes at least a status indication for each of the active or inactive IPTV streams and an identifier for active ones of the IPTV streams, wherein the identifier indicates a particular viewing device associated with one of the remote devices within the home viewing network.

18. The medium of claim 17 further including instructions for presenting actions with respect to each of the active and inactive IPTV streams with the descriptive information.

19. The medium of claim 18 further including instructions for receiving and processing selected ones of the actions.

20. The medium of claim 19, wherein processing the selected ones of the actions includes at least one of altering assignments of a number of the IPTV streams between a number of the remote devices, passing control of a particular one of the IPTV streams from one of the remote devices to another one of the remote devices, and joining a particular one of the IPTV streams between two of the remote devices.

21. The medium of claim 19, wherein processing a particular selected one of the actions includes canceling an existing recording associated with one of the IPTV streams.

22. A system including:
an Internet Protocol Television (IPTV) stream manager; and
remote IPTV stream devices, wherein the IPTV stream manager is to interact with each of the remote IPTV devices to provide descriptive information for IPTV streams within a home viewing network, and wherein each of the remote IPTV stream devices is to instruct the IPTV stream manger to take a number of actions in response to the descriptive information, and wherein the descriptive information includes at least a status for each of the IPTV streams and a location for each of the IPTV streams within the home viewing network.

23. The system of claim 22, wherein each of the remote IPTV devices are interfaced to a viewing device within the home viewing network.

24. The system of claim 23, wherein at least one of the remote IPTV devices is interfaced to a Set-Top Box (STB).

25. The system of claim 22, wherein the actions include at least one of an option for one of the remote IPTV devices to join a particular one of the IPTV streams associated with another one of the remote IPTV devices, another option for one of the remote IPTV devices to take or request control of a particular one of the IPTV streams associated with another one of the remote IPTV devices, and still another option for one or the remote IPTV streams to cancel a recording associated with a particular one of the IPTV streams.

26. The system of claim 22, wherein the IPTV stream manager includes an interface that is presented to each of the remote IPTV devices, and wherein the interface is used to present the descriptive information and the actions and used to receive selections of the actions from each of the remote IPTV devices.

27. The system of claim 22, wherein the IPTV stream manager is to issue a warning to each of the remote IPTV devices when a maximum number of the available IPTV streams within the home viewing network is reached or is being approached within a predefined threshold.

28. A set-top-box (STB), including:
a device adapted to interact with an Internet Protocol Television (IPTV) server to present on a viewing device metadata information associated with a plurality of IPTV streams located throughout the home viewing network, and wherein the metadata information includes at least a location identifier for each of the plurality of IPTV streams.

29. The STB of claim 28, wherein the device is further adapted to interact with the IPTV server through a remote viewing device that is local to the STB, and wherein the remote viewing device is to directly interact with the IPTV server on behalf of the STB.

30. The STB of claim 28, wherein the device is adapted to receive instruction from other remote devices for purposes of canceling an existing recording associated with one of the IPTV streams and initiating another recording associated with a different one of the IPTV streams, and wherein the instruction is received via the IPTV server acting as an intermediary between the device and the other remote devices.

31. An Internet Protocol Television (IPTV) server, including:
an IPTV stream manager adapted to interact with a plurality of remote devices within a home viewing network, wherein the IPTV stream manager is to supply metadata associated with a plurality of available IPTV streams to each of the remote devices and wherein the metadata includes location identifiers for each of the available IPTV streams within the home viewing network.

32. The IPTV server of claim 31, wherein the IPTV stream manager is to relay communications occurring between the remote devices acting as an intermediary within the home viewing network.

33. The IPTV server of claim 31, wherein the IPTV stream manager is to include with the metadata at least one of channel numbers associated with each of the IPTV streams, descriptive titles associated with each of the IPTV streams, and descriptive summaries associated with programming occurring on each of the IPTV streams.
